(19) United States
(12) Patent Application Publication
(10) Pub. No.: US 2026/0309676 A1
(43) Pub. Date: Oct. 8, 2026

(54) A GUIDED WAVE AND GENETIC ALGORITHM-BASED INVERSION PROCESS FOR THE AUTOMATIC CHARACTERIZATION OF PILE FOUNDATIONS

(71) Applicant: ÉCOLE POLYTECHNIQUE DE MONTRÉAL, Montreal (CA)

(72) Inventors: Pooneh MAGHOUL, Montreal (CA); Shihao CUI, Montreal (CA)

(21) Appl. No.: 19/476,227

(22) PCT Filed: Apr. 19, 2024
(86) PCT No.: PCT/CA2024/050516

§ 371 Date: Oct. 17, 2025

Related U.S. Application Data
(60) Provisional application No. 63/497,262, filed on Apr. 20, 2023.

(51) Int. Cl. G01N 29/12; G01N 29/04; G01N 29/44

(52) U.S. Cl. CPC G01N 29/12; G01N 29/043; G01N 29/045; G01N 29/4472; G01N 2291/0232

(57) ABSTRACT

A computerized method for determining a value of at least one characteristic of a structure having a buried portion and a non-buried portion, the method comprising the steps of: impacting the structure on a lateral side of the non-buried portion to cause an excitation within the structure; acquiring an excitation response signal with a receiver placed on the lateral side of the non-buried portion and generating excitation response data; determining a resonance number and a resonance frequency from the excitation response data; performing an inversion process based on guided wave theory and a genetic algorithm to determine the value of the at least one characteristic of the structure.

### FIELD

Aspects of this disclosure relate to the characterization of pile foundations.

### BACKGROUND

Technological, economic and environmental sustainability in civil engineering drives reuse and retrofitting of foundations in redevelopment projects [3, 1]. Pile foundations have been widely used in construction projects. There is a large number of unknown pile foundations whose original design plan cannot be retrieved. For example, according to the National Bridge Inventory in 2016, about 28,000 bridges are identified with unknown pile foundations in the United States [19]. To sustain the safety of these bridges as well as for redevelopment purposes, it is useful to characterize the geometric and mechanical properties of these foundations. The pile length is an important geometric parameter to estimate the bearing capacity and the scour level of a pile [12, 25]. Also, the mechanical properties of the pile, such as the longitudinal wave velocity, the shear wave velocity, and the density, can be used to evaluate its performance under different circumstances. For example, the stress wave speed can be used for the pile integrity analysis [9].

Surface non-destructive testing (NDT) methods have attracted much attention for unknown pile foundation characterization because of their non-invasive nature and convenience. There are various surface NDT methods to solely estimate pile length based on either the longitudinal or flexural (or bending) stress waves generated in the pile. The methods based on the longitudinal wave are applied when the impact excitation is placed on the top surface of the pile, while the methods based on the flexural wave are applied when the impact excitation is placed on the lateral side of the test pile. The selection between these two methods for a specific case depends on the accessibility of the top surface or the lateral side of the test pile.

The techniques based on the longitudinal wave include the sonic echo (SE) and the impulse response (IR), which are among the most popular NDT techniques for pile length estimation. In the SE method, the difference between the echo of the incident wave and the reflected wave in the time-series waveform is identified [13]. In the IR method, the difference between the frequency peak of the response spectrum, which is converted by the time-series waveform, is identified [15]. In these two methods, generally, the longitudinal wave speed is used for pile length estimation based on the time difference observed in the time-series waveform or the frequency difference in the frequency-domain spectrum. The guided waves can also be used for pile length estimation. The guided waves have different modes corresponding to different positions of impact applied to the test pile. When the impact is applied on the top surface, the longitudinal mode dispersion relation of the guided wave may be used; when the impact is placed on the lateral side causing bending, the flexural mode dispersion relation of the guided wave may be used. Wang used the first branch dispersion relation of the longitudinal wave and resonance frequency of an impact response to estimate the pile length.

For the dispersion wave analysis using the flexural mode, the short kernel method (SKM) was proposed when the impact is applied on the lateral side of the test pile [8]. An SKM plot in the time domain can be obtained and the phase velocity and the echo time can be determined from the plot to estimate the pile length [7]. However, the identification of the frequency peak and the short kernel is cumbersome and it is not accurate for deep pile foundations. In order to increase the resolution of the traditional SKM, the Hilbert Huang transform (HHT) was added to SKM for timber pile length estimation [10]. Samu and Guddati [19, 20] developed a pile length estimation method using the relation between the phase difference and the wavenumber. In their approach, two signals are collected on the lateral side of the test pile for the phase difference calculation. The periodic pattern of the phase difference with regard to the wavenumber is used for pile length estimation. Then, the dispersion relation is built by the 1D Timoshenko beam model. Yu [27] also estimated the pile length by the 1D Timoshenko beam model based on the signal collected on the lateral side of the test pile. Based on the frequency peak of the spectrum of the signal and the phase velocity estimated by the Timoshenko beam model-based dispersion relation, the pile length can be determined. Wang and Wang [23] mapped the resonant frequency of the signal collected on the lateral side with the flexural guided wave mode. The SKM, continuous wavelet transform (CWT), and the flexural mode dispersion relation of the guided wave model are also combined for signal processing to perform pile length estimation [14, 21].

It is worth mentioning that the above-mentioned methods are only effective when the shear and longitudinal velocities (or the related physical properties) are given or estimated ahead of time. In the other words, the length and the mechanical properties of the pile as the shear and longitudinal wave velocities and the density cannot be estimated simultaneously and automatically.

### SUMMARY

In one aspect, a computerized method for determining a value of at least one characteristic of a structure having a buried portion and a non-buried portion, the method comprising the steps of:
impacting the structure on a lateral side of the non-buried portion to cause an excitation within the structure;
acquiring an excitation response signal with a receiver placed on the lateral side of the non-buried portion and generating excitation response data;
determining a resonance number and a resonance frequency from the excitation response data;
performing an inversion process based on guided wave theory and a genetic algorithm to determine the value of the at least one characteristic of the structure.

In another aspect, a system for determining a value of at least one characteristic of a structure having a buried portion and a non-buried portion, the method comprising the steps of:
an excitation source caused to generate an excitation within the structure by applying a force on a lateral side of the non-buried portion of the structure;
one signal receiver placed on the lateral side of the non-buried portion of the structure, wherein the signal receiver acquires a response signal resulting from the excitation;
an apparatus for receiving the response signal, wherein the apparatus includes a processor, a memory for storing instructions executable by the processor to at least:
convert the response signal into response data;
determine a resonance number and a resonance frequency from the response data; and
perform an inversion process based on guided wave theory and a genetic algorithm to determine the value of the at least one characteristic of the structure.

In another aspect, a computerized method of determining a value of at least one characteristic of a structure having a buried portion and a non-buried portion by applying at least one non-destructive testing (NDT) modality to the structure, the method comprising the steps of:
receiving excitation response data, wherein excitation response data is derived from a response signal acquired from one signal receiver placed on a lateral side of the non-buried portion, and wherein an excitation within the structure is caused by an excitation source placed on a lateral side of the non-buried portion;
determining a resonance number and a resonance frequency from the excitation response data; performing an inversion process based on guided wave theory and a genetic algorithm to determine the value of the at least one characteristic of the structure.

In another aspect, there is provided an inversion method for pile characterization, in terms of geometric and mechanical properties, based on the guided wave theory and genetic algorithm (GA). In one example, the guided wave model for a cylindrical pile is built by Helmholtz's decomposition-based spectral element method, and the forward model is built based on the flexural model-based dispersion relation. The resonance analysis for the general solution of the guided wave model is performed for the first time. Two boundary conditions for the test pile, the displacement and the stress control boundary conditions, can be used for the resonance analysis. Next, the resonance data is mapped with the phase velocity, and a loss function of the inversion process is obtained by the difference between the experimental phase velocity and the simulated phase velocity derived from the forward model. The loss function of the GA-based inversion process is obtained for the two different boundary conditions mentioned above. Finally, the experimental data has been used to validate the effectiveness and accuracy of the present method.

The inversion algorithm is developed based on the guided wave model and GA for the estimation of the mechanical properties (Young's modulus (E), density (ρ), and Poisson's ratio (v)) and the geometric property (pile length (L)) of the test pile. In this inversion process, the loss function is obtained through Mean Squared Error (MSE), which is the average of the squared difference between the actual and the predicted value for the featured data sets (E, ρ, v, L). The predicted data is generated by the forward solver based on the guided wave model. As shown in FIG. 1a, the forward model, denoted by DPR (fₙ, E, ρ, v) is built by the dispersion relation obtained for a cylindrical pile, where fₙ is the resonance frequency given by the experimental data in FIG. 1a.

The dispersion relation is established by Helmholtz's decomposition-based spectral element method, as described below, and solved by a modified Ridders' algorithm. Since two assumptions are made for the boundary conditions of the test pile (i.e., the displacement and the stress control boundary conditions, respectively), two different methods to obtain the loss function are presented. Then, the GA operators, including selection, crossover and mutation are used for the variable updating. The inversion results for pile characterization can be obtained when the GA-based optimization process reaches its convergence.

In this disclosure, by resonance analysis, the relation of the pile length, the resonance data (the resonance number and the resonance frequency), and the phase velocity was established. Then, the pile length can be estimated by with the experimental phase velocity and the resonance data. Cui et al. [6] proposed a dispersion analysis method for pile length estimation combining the phase difference and the three-dimensional (3D) guided wave model. The dispersion relation between the wavenumber and the angular frequency is determined by the first branch dispersion relation of the longitudinal mode of the present guided wave model. In this method, the guided wave model is built by the spectral element method; the phase difference is calculated based on the two signals collected on either the lateral side or top surface of the pile; the periodic pattern of the phase difference with regard to the wavenumber is used for pile length estimation. However, the periodic pattern in the dispersion curve of this method may appear at the relatively high frequency range. As such, a relatively higher excitation frequency of the impact may be required. To overcome this problem, Cui and Maghoul [5] proposed a method to analyze the periodic pattern of the normalized magnitude of the response in the frequency domain of the signal collected by only one sensor. The sensor can be placed either on the lateral side or the top surface depending on the accessibility of the pile. In this approach, the first branch of the longitudinal mode of the guided wave is used to derive the dispersion relation. The periodic pattern of the normalized magnitude and the wavenumber in the relatively lower frequency range of the response can be used for pile length estimation.

The pile characterization method described herein non-invasively estimates the length and mechanical properties of a pile simultaneously and automatically. The forward model is established based on the guided wave theory for a cylindrical pile and a genetic algorithm-based method is employed for the inversion process. The guided wave model is built using the spectral element method, which can generate the dispersion relation for the given physical properties. The resonance data (including the resonance frequency and the resonance number) and pile length can be related to the phase velocity, which can be derived by assuming either the displacement control or stress control boundary conditions. The loss function in the inversion method is defined by linking the dispersion relation of the forward model and the resonance analysis for those two boundary conditions. The method is validated against the experimental data. In one example, the average accuracy of the present method for characterizing the pile properties (such as pile length, shear wave velocity, and longitudinal wave velocity) and the pile length is within 5% error for each variable.

In another aspect, a method to inversely estimate the properties of unknown piles, including the physical and geometric properties simultaneously. The forward model is built using the flexural mode-based dispersion relation based on the guided wave theory for a cylindrical pile. The fitness of the optimization algorithm is built using the stress control boundary condition and displacement control boundary condition. The inversion process of optimization is performed by GA. The effectiveness and accuracy of the present method are validated against the experimental test results. In one example, the present method can achieve an average accuracy within 5% error.

### BRIEF DESCRIPTION OF THE DRAWINGS

FIG. 1a shows a schematic flowchart of the method of the techniques described herein;

FIG. 1b shows a flowchart outlining example steps for quantifying the characteristics of a pile foundation;

FIG. 2 shows a schematic diagram of the experimental data acquisition.

FIG. 3a shows a spectrum of the signal S_{0,1} of the experimental data for resonance data identification reproduced from [23];

FIG. 3b shows a spectrum of the signal S_{0,2} of the experimental data for resonance data identification reproduced from [23];

FIG. 3c shows a spectrum of the signal S_{0,3} of the experimental data for resonance data identification reproduced from [23];

FIG. 3d shows a spectrum of the signal S_{1,1} of the experimental data for resonance data identification reproduced from [23];

FIG. 3e shows a spectrum of the signal S_{1,2} of the experimental data for resonance data identification reproduced from [23];

FIG. 3f shows a spectrum of the signal S_{1,3} of the experimental data for resonance data identification reproduced from [23];

FIG. 4a shows the experimental and theoretical phase velocity of vibration signal S_{0,1};

FIG. 4b shows the experimental and theoretical phase velocity of vibration signal S_{0,2};

FIG. 4c shows the experimental and theoretical phase velocity of vibration signal S_{0,3};

FIG. 4d shows the experimental and theoretical phase velocity of vibration signal S_{1,1};

FIG. 4e shows the experimental and theoretical phase velocity of vibration signal S_{1,2};

FIG. 4f shows the experimental and theoretical phase velocity of vibration signal S_{1,3};

FIG. 5a shows the absolute error rate of the inversion result of the variable L, c_{b}, cₛ and cₚ, using the loss function Fₛ and F_{d} for the signal S_{0,1};

FIG. 5b shows the absolute error rate of the inversion result of the variable L, c_{b}, cₛ and cₚ, using the loss function Fₛ and F_{d} for the signal S_{0,2};

FIG. 5c shows the absolute error rate of the inversion result of the variable L, c_{b}, cₛ and cₚ, using the loss function Fₛ and F_{d} for the signal S_{0,3};

FIG. 5d shows the absolute error rate of the inversion result of the variable L, c_{b}, cₛ and cₚ, using the loss function Fₛ and F_{d} for the signal S_{1,1};

FIG. 5e shows the absolute error rate of the inversion result of the variable L, c_{b}, cₛ and cₚ, using the loss function Fₛ and F_{d} for the signal S_{1,2};

FIG. 5f shows the absolute error rate of the inversion result of the variable L, c_{b}, cₛ and cₚ, using the loss function Fₛ and F_{d} for the signal S_{1,3};

FIG. 6a shows a fitness at different iteration numbers of GA for different signals based on the fitness Fₛ; and

FIG. 6b shows a fitness at different iteration numbers of GA for different signals based on the fitness F_{d}; and

FIG. 7 shows a high-level architecture block diagram of a system for quantifying the characteristics of a pile foundation.

### DETAILED DESCRIPTION

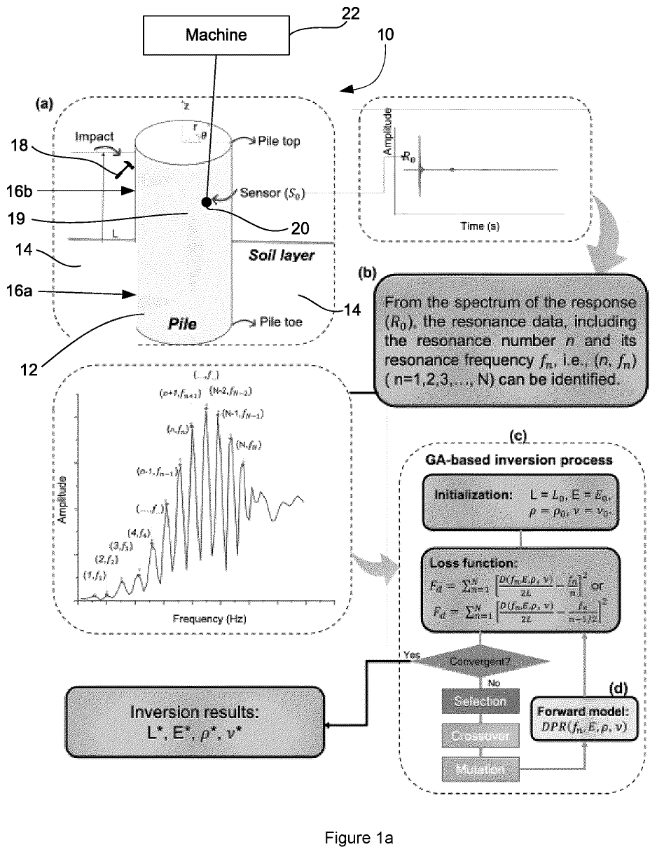

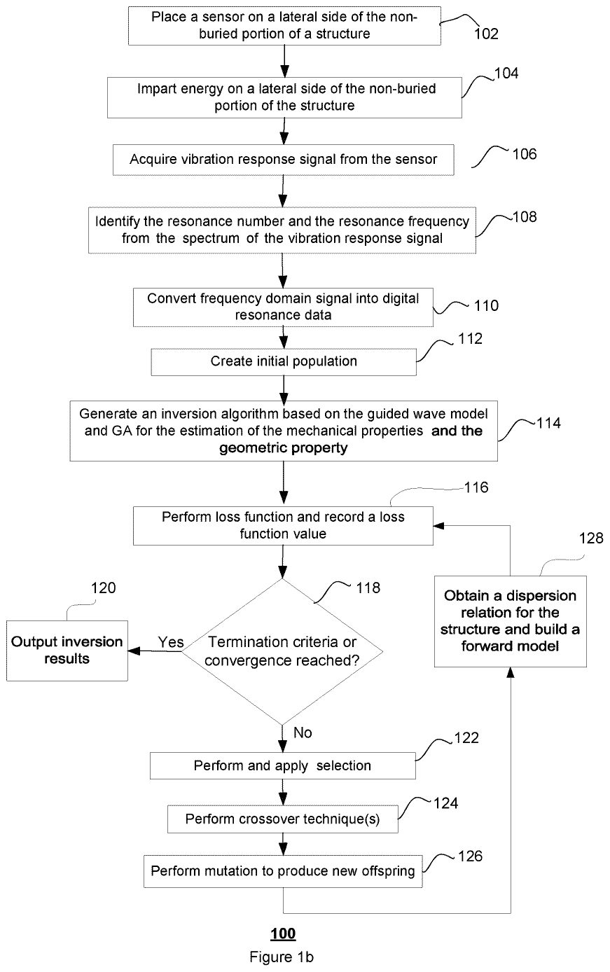

FIG. 1a illustrates generally an exemplary system that can be used to perform one or more techniques for determining the characteristics of a structure described in this disclosure, general designated by numeral 10, in one implementation. Structure 12 is anchored within a material 14, such as soil, sand, rock, and any combination thereof. Accordingly, the structure 12 includes buried portion 16a surrounded by material 14, and therefore inaccessible, and a non-buried portion 16b which is free of the material 14 and accessible. The structure 12 may be a pile foundation. An excitation source 18 may be selectively and periodically actuated to impart energy on a lateral side 19 of the non-buried portion 16a to cause an excitation within the structure 12. A sensor or signal receiver 20 placed on the lateral side 19 of the non-buried portion 16a acquires a raw excitation response signal and sends the raw excitation response signal to a machine or apparatus 22, such as a computing device, where the raw excitation response signal is converted to excitation response data. A resonance number and a resonance frequency are calculated by the machine 22, and an inversion process based on guided wave theory is performed by the machine 22, which uses a genetic algorithm to determine values of the characteristics of the structure 12. The excitation source 18 may be a hammer, and sensor 20 is preferably secured in essentially fixed relation to the structure 12. In one example, sensor 20 is a geophone.

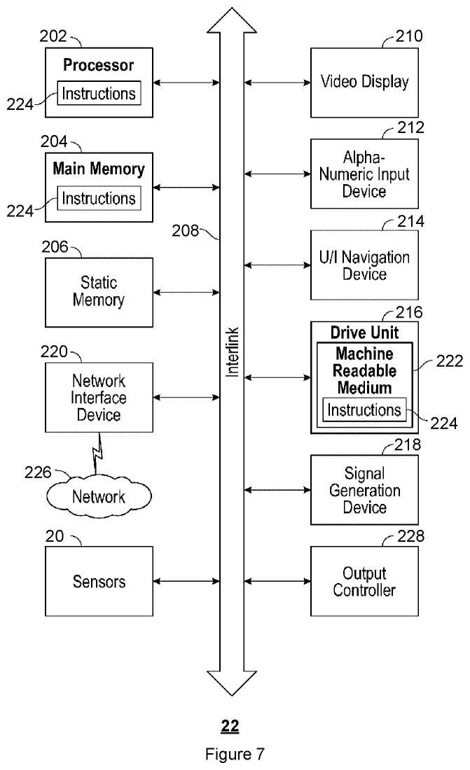

Machine 22 comprises a processor, a memory for storing data associated with the response signal received from the sensor 20, and for storing computer readable instructions executable by the processor to at least, receive the detected excitation response signals from sensors 20, and determine the characteristics of the structure 12. Accordingly, through analysis of these detected vibration response signals, the characteristics of the structure 12, such as estimation of the mechanical properties (Young's modulus (E), density (ρ), and Poisson's ratio (v)) and the geometric property (pile length (L) of the test pile, may be determined. More details of machine 22 are described below with reference to FIG. 7.

FIG. 1b shows flow diagram 100 depicting a computer-implemented method for determining the characteristics of a structure by processing vibration response data in accordance with various implementations described herein. It should be understood that while the operational flow diagram indicates a particular order of execution of the operations, in other implementations, the operations might be executed in a different order. Further, in some implementations, additional operations or blocks may be added to the method. Likewise, some operations or blocks may be omitted.

At block 102, a sensor 20 is placed on the lateral side 19 of a non-buried portion 16b of a structure 12, such as a test pile foundation.

At block 104, the lateral side 19 of the non-buried portion 16b of the test pile foundation 12 is impacted by a hammer 18, or some other means for causing vibrations within the test pile foundation 12.

At block 106, a vibration signal within the test pile foundation 12 is detected by the sensor 20 (also denoted by S₀ in FIG. 1a). The vibration signal acquired by sensor 20, denoted by R₀, can be in terms of velocity or acceleration, or the combination of the velocity and a force signal. The sensor 20 may include an accelerometer or a geophone or any suitable signal receiver or transducer capable of acquiring recordings for the determination of acceleration, velocity or displacement. In one example, force response can be recorded by a force transducer.

At block 108, the raw vibration signal is converted from a time domain into the frequency domain. In one example, a spectrum of the collected responses may be obtained using the Fast Fourier transform (FFT), and a resonance number and a resonance frequency are identified from the spectrum of the signal. Generally, the signals of acceleration, velocity or the combination of velocity and force signals may be used for resonance analysis. In this example, acceleration is used for resonance analysis. To obtain the resonance data, the spectrum here can be the mobility curve (referring to the quotient between the spectrum of the force signal and the spectrum of the velocity signal), the velocity signal and the acceleration signal [4]. The resonance data can be mapped with the phase velocity or the pile length, as will be described in detail below.

At block 110, the machine 22 receives the frequency domain signal from the analog signal acquisition module 22, and converts into digital resonance data.

The inversion process for pile characterization is initiated, and at block 112, an initial population is generated.

At block 114, an inversion process is implemented, in which an inversion algorithm is developed based on the guided wave model and a genetic algorithm (GA) for the estimation of the mechanical properties (Young's modulus (E), density (ρ), and Poisson's ratio (v)) and the geometric property (pile length (L)) of the test pile.

At block 116, a loss function is obtained through Mean Squared Error (MSE), which is the average of the squared difference between the actual and the predicted value for the featured data sets (E, ρ, v, L). Since two assumptions are made for the boundary conditions of the test pile (i.e., the displacement and the stress control boundary conditions, respectively), two different methods to obtain the loss function may be employed.

At block 118, a determination is made as to whether there is convergence between the actual and the predicted value of the physical or geometric property characteristic.

At block 120, the inversion results (such as L*, E*, ρ*, v*) for pile characterization can be obtained when the GA-based optimization process reaches its convergence. When convergence has not been reached, then GA operators, including selection, crossover and mutation are used to update the variables.

Accordingly, at block 122, a selection operator is performed, based on the survival probability and the survival probability depends on the fitness of the individual. Generally, individuals with high fitness are more likely to survive and are more likely to get mating rights, while individuals with low fitness are easily eliminated.

At block 124, a crossover operator is employed to replace the parts of the parent's individual, thus generating the operator of the new individual. This operator selects two individuals randomly in a pairing library according to certain cross probability.

At block 126, a mutation operator is performed, and this operator can avoid information loss caused by selection and crossover, maintain individual diversity, ensure the effectiveness of the genetic algorithm, and make the algorithm have strong local search ability and prevent premature convergence.

At block 128, a forward model, denoted by DPR (fₙ, E, ρ, v), is built using the dispersion relation obtained for a cylindrical pile, where fₙ is the resonance frequency given by the experimental data in FIG. 1(b). The dispersion relation is established by Helmholtz's decomposition-based spectral element method (presented below) and solved by a modified Ridders' algorithm. The predicted data is generated by the forward solver based on the guided wave model, and the updated variables are returned to the loss function block 116.

A description of a forward model based on the guided wave theory, as used in the methods described herein now follows.

The Naiver-Stokes equation can be applied to describe the propagation of guided waves in homogeneous materials, as follows:

$$( λ + μ ) ∇ ∇ \cdot u + μ {∇}^{2} u = ρ \frac{{\partial }^{2} u}{\partial {t}^{2}} \qquad ( 1 )$$

in which ∇ is the gradient operator, i.e.,

$$i \frac{\partial }{\partial x} + j \frac{\partial }{\partial y} + k \frac{\partial }{\partial z}$$

(i, j and k are the unit vector in the x, y and z direction respectively); ∇² represents the Laplace operator, i.e.,

$$\frac{{\partial }^{2}}{\partial {x}^{2}} + \frac{{\partial }^{2}}{\partial {y}^{2}} + \frac{{\partial }^{2}}{\partial {z}^{2}} ; ∇ \cdot$$

is the divergence operator, i.e.,

$$\frac{\partial }{\partial x} + \frac{\partial }{\partial y} + \frac{\partial }{\partial z} ;$$

u is the displacement vector. λ and μ are the Lamé coefficients, and their values can be calculated by Young's modulus (E) and Poisson's ratio (v), i.e.,

$$λ = \frac{Ev}{( 1 + v ) ( 1 - 2 v )} \qquad ( 2 a )$$

$$μ = \frac{E}{2 ( 1 + v )} \qquad ( 2 b )$$

According to Helmholtz's decomposition method, the displacement field u in Equation (1) can be decomposed into two components: the non-rotational longitudinal component (φ) and the rotational shear vector component (\vec{ψ}), where φ is the scalar longitudinal (compressional) wave potential and \vec{ψ} indicates the shear (transverse) wave vector potential, as follows [19]:

$$u = ∇ ϕ + ∇ \times \vec{ψ} . \qquad ( 3 )$$

To satisfy the uniqueness of the solution, the Gauge condition should be applied, that is [18],

$$∇ \cdot \vec{ψ} = 0. \qquad ( 4 )$$

Two uncoupled partial differential equations (PDEs) are obtained by substituting Equation (3) into Equation (1). The first equation is related to the longitudinal wave (P wave) associated with the scalar potential φ; the second equation is related to the shear wave (S wave) potential associated with the vector potential \vec{ψ}. The two PDEs are,

$${c}_{p}^{2} {∇}^{2} ϕ - \frac{{\partial }^{2} ϕ}{\partial {t}^{2}} = 0 , \qquad ( 5 a )$$

$${c}_{s}^{2} {∇}^{2} \vec{ψ} - \frac{{\partial }^{2} \vec{ψ}}{\partial {t}^{2}} = 0 , \qquad ( 5 b )$$

where cₚ is the longitudinal wave velocity and cs is the shear wave velocity, as follows:

$${c}_{p} = \sqrt{( λ + 2 μ ) / ρ} = {c}_{b} \sqrt{\frac{1 - v}{( 1 + v ) ( 1 - 2 v )}} \qquad ( 6 a )$$

$${c}_{s} = \sqrt{μ / ρ} = {c}_{b} \sqrt{\frac{1}{2 ( 1 + v )}} \qquad ( 6 b )$$

in which c_{b} is the bar velocity.

In the cylindrical coordinate system (r, θ, z), the displacements in the r, θ and z directions, denoted by uᵣ, u_{θ} and u_{z}, respectively, can be calculated as [20],

$${u}_{r} = \frac{\partial ϕ}{\partial r} + \frac{1}{r} \frac{\partial {ψ}_{z}}{\partial θ} - \frac{\partial {ψ}_{θ}}{\partial z} \qquad ( 7 a )$$

$${u}_{θ} = \frac{1}{r} \frac{\partial ϕ}{\partial θ} + \frac{1}{r} \frac{\partial }{\partial z} - \frac{\partial {ψ}_{z}}{\partial r} \qquad ( 7 b )$$

$${u}_{z} = \frac{\partial ϕ}{\partial z} + \frac{1}{r} \frac{\partial ( {ψ}_{θ} r )}{\partial r} - \frac{1}{r} \frac{\partial {ψ}_{r}}{\partial θ} \qquad ( 7 c )$$

where ψᵣ, ψ_{θ} and ψ_{z} are the components of the vector potential \vec{ψ} in the r, θ and z directions, respectively, and they satisfy the following conditions:

$${∇}^{2} {ψ}_{r} - \frac{{ψ}_{r}}{{r}^{2}} - \frac{2}{{r}^{2}} \frac{\partial {ψ}_{θ}}{\partial θ} = \frac{1}{{c}_{s}^{2}} \frac{{\partial }^{2} {ψ}_{r}}{\partial {t}^{2}} \qquad ( 8 a )$$

$${∇}^{2} {ψ}_{θ} - \frac{{ψ}_{θ}}{{r}^{2}} + \frac{2}{{r}^{2}} \frac{\partial {ψ}_{r}}{\partial θ} = \frac{1}{{c}_{s}^{2}} \frac{{\partial }^{2} {ψ}_{θ}}{\partial {t}^{2}} \qquad ( 8 b )$$

$${∇}^{2} {ψ}_{z} = \frac{1}{{c}_{s}^{2}} \frac{{\partial }^{2} {ψ}_{z}}{\partial {t}^{2}} \qquad ( 8 c )$$

$$where {∇}^{2} = \frac{{\partial }^{2}}{\partial {r}^{2}} + \frac{1}{r} \frac{\partial }{\partial r} + \frac{1}{{r}^{2}} \frac{{\partial }^{2}}{\partial {θ}^{2}} + \frac{{\partial }^{2}}{\partial {z}^{2}} .$$

In the cylindrical coordinate system, the general solution of the potentials of φ and \vec{ψ} in Equations (5) can be expressed as follows [10]:

$$\hat{ϕ} = {f}_{ϕ} ( r ) {Θ}_{ϕ} ( θ ) {e}^{i ( kz - ω t )} , \qquad ( 9 a )$$

$${\hat{ψ}}_{r} = {h}_{r} ( r ) {Θ}_{r} ( θ ) {e}^{i ( kz - ω t )} , \qquad ( 9 b )$$

$${\hat{ψ}}_{θ} = {h}_{θ} ( r ) {Θ}_{θ} ( θ ) {e}^{i ( kz - ω t )} , \qquad ( 9 c )$$

$${\hat{ψ}}_{z} = {h}_{z} ( r ) {Θ}_{z} ( θ ) {e}^{i ( kz - ω t )} , \qquad ( 9 d )$$

where k is the wavenumber of the propagating wave and ω is the angular frequency; f_{φ}(r), hᵣ(r), h_{θ}(r) and h_{z}(r) are assumed functions in terms of r for solving potentials; Θ_{φ}(θ), Θᵣ(θ), Θ_{θ}(θ) and Θ_{z}(θ) are assumed functions in terms of θ for solving potentials.

The potentials φ, ψᵣ, ψ_{θ} and ψ_{z} can be derived as Equation (10), and the detail of the derivation process is given in Appendix A.

$$ϕ = A * {J}_{ξ} ( {k}_{p} r ) cos ξθ {e}^{i ( kz - ω t )} , \qquad ( 10 a )$$

$${ψ}_{r} = B * {J}_{ξ} ( {k}_{s} r ) sin ξθ {e}^{i ( kz - ω t )} , \qquad ( 10 b )$$

$${ψ}_{θ} = C * {J}_{ξ + 1} ( {k}_{s} r ) cos ξθ {e}^{i ( kz - ω t )} , \qquad ( 10 c )$$

$${ψ}_{z} = - C * {J}_{ξ + 1} ( {k}_{s} r ) sin ξθ {e}^{i ( kz - ω t )} , \qquad ( 10 d )$$

where A*, B* and C* are the unknown coefficients; ξ is the circumferential order.

A description of a forward model using the dispersion relation, as used in the methods described herein now follows.

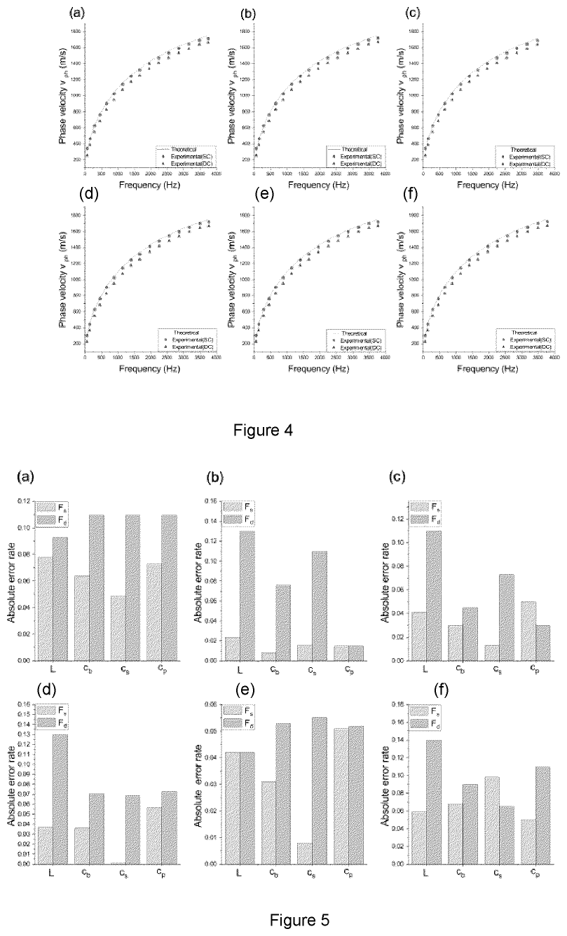

The displacement in different directions uᵣ, u_{θ} and u_{z} can be calculated using the potentials in Equations (10) and Equation (8). When the longitudinal mode of the guided wave is considered, considering the symmetric nature of this kind of wave, the displacement in the θ direction can be regarded as 0, and therefore here ξ=0. As such, \hat{ψ}ᵣ and \hat{ψ}_{z} are zero in Equation (10) [6]. In this disclosure, to investigate the pile with its top surface in service and inaccessible, the pile is impacted on its lateral side and the sensor are placed on the lateral side of the pile. The lateral impact corresponds to the flexural mode of the guided wave [27]. The dispersion relation of the flexural guided wave is denoted by F(ξ, q), where the circumferential order ξ is a non-negative integer [10] and q is the branch number. Because the flexural guided wave is asymmetric, there is ξ>0 to ensure that displacement components uᵣ, u_{θ} and u_{z} are not constantly equal to zero. For frequencies excited by the hammer impact in the test, the dispersion relation of F(1, 1), that is ξ=1 and q=1, is the predominant mode [21, 4]. That means only the guided wave of the mode F(1, 1) can be clearly measured in this case, and the guided wave with higher orders or branches usually with tiny energy cannot be measured in this case. Therefore, the guided wave of the mode F(1, 1) is selected for the forward model building. In FIGS. 4a-f, the experimental dispersion relation extracted from the experimental data can validate this point.

The stress in different directions can also be calculated, as follows:

$${σ}_{rr} = λ ( \frac{\partial {u}_{r}}{\partial r} + \frac{{u}_{r}}{r} + \frac{1}{r} \frac{\partial {u}_{θ}}{\partial θ} + \frac{\partial {u}_{z}}{\partial z} ) + 2 μ \frac{\partial {u}_{r}}{\partial r} , \qquad ( 11 a )$$

$${σ}_{r θ} = μ ( \frac{\partial {u}_{θ}}{\partial θ} - \frac{{u}_{θ}}{r} + \frac{1}{r} \frac{\partial {u}_{r}}{\partial θ} ) , \qquad ( 11 b )$$

$${σ}_{rz} = μ ( \frac{\partial {u}_{r}}{\partial r} + \frac{\partial {u}_{z}}{\partial r} ) . \qquad ( 11 c )$$

Here the free traction condition is used to determine the dispersion relation D(ω, k). That is the zero-stress condition on the cylindrical pile's surface, i.e., the stress σᵣᵣ=σ_{rθ}=σ_{rz}=0 (r=R, R is the pile radius). Then, we obtain:

$$M [ \begin{matrix}A \\ B \\ C\end{matrix} ] = [ \begin{matrix}0 \\ 0 \\ 0\end{matrix} ] \qquad ( 12 )$$

where M is a 3×3 matrix and the components are given in Appendix B.

To have non-trivial solutions, the determinant of the square matrix M should be equal to zero, that is |M|=0; then, the dispersion relation between the angular frequency ω and wavenumber k can be obtained. We used a modified Ridders' root-searching algorithm proposed by Cui et al. [6] to determine the dispersion relation. The obtained dispersion relation is then used to inversely estimate the featured pile properties, including E, ρ, v and L. The dispersion relation determined in this part is used as the forward model, denoted by DPR(f, E, ρ, v), where f=ω/2π is the resonance frequency (Hz). The forward model DPR (f, E, ρ, v) can yield a theoretical phase velocity, denoted by

$${v}_{p h}^{th} ,$$

at the given resonance frequency f for the pile with the given physical properties E, ρ and v, that is,

$${v}_{p h}^{th} = D P R ( f , E , ρ , v ) , \qquad ( 13 )$$

For the concrete pile, the density is approximately 2400 kg/m³. Then according to the definition of the bar velocity c_{b}, Young's modulus (E) can be estimated using c_{b} and E. As shown in Equation (6), the property set of Young's modulus E, density ρ and Poisson's ratio v can be interchangeable with the property set of the longitudinal wave velocity cₚ, the shear wave velocity cₛ and the bar velocity c_{b}. Therefore, the forward model built by E, ρ and v in Equation (13) can also be rewritten in terms of c_{b}, cₛ and cₚ, as follows:

$${v}_{p h}^{th} = D P R ( f , {c}_{b} , {c}_{p} , {c}_{s} ) . \qquad ( 14 )$$

In this disclosure, the dispersion relation is used to inversely characterize the pile property. The dispersion relation is a property of the medium, which is independent of the boundary conditions. In the forward model, the synthetic dispersion relation can be generated given the mechanical property. The accuracy of the forward model can be verified with a comparison with a 1D approximation model, such as the Timoshenko beam model. The forward model, that is the dispersion relation built by the 3D guided wave model, is compared with the dispersion relation extracted from the experimental data in FIGS. 4a-f. The comparison shows that the forward model fits well with the experimental result, which can validate the accuracy of the forward model.

The resonance analysis of the response of guided waves as used in the methods described herein now follows.

In one example, the resonance of the response based on the 3D guided wave model is analyzed using the displacement in the radial direction uᵣ(z, t). According to Equation (7a), uᵣ(z, t) can be expressed as,

$${u}_{r} ( z , t ) = {C}_{0} ( ω , k , θ , r ) {e}^{i ( k z \_ω t )} , \qquad ( 15 )$$

$$where$$

$${C}_{0} ( ω , k , θ , r ) = ( \frac{A {k}_{p}}{2} ( {J}_{0} ( {k}_{p} r ) - {J}_{2} ( {k}_{p} r ) ) + \frac{B}{r} {J}_{1} ( {k}_{s} r ) + C i k {J}_{2} ( {k}_{s} r ) ) cos θ ,$$

in which A, B and C are the unknown coefficients; kₛ and kₚ are a function of k and ω. Therefore, C₀(ω, k, θ, r) is a function of ω, θ, k and r and is independent of z. The displacement uᵣ when the incident and reflected waves are considered, can be expressed as,

$${u}_{r} ( z , t ) = {C}_{0} {e}^{i ( k z \_ω t )} + {C}_{0}^{′} {e}^{i ( - k z \_ω t )} \qquad ( 16 )$$

where C₀ is responsible for the incident wave while

$${C}_{0}^{′}$$

is responsible for the reflected wave. For the resonance analysis, the boundary condition of the pile top and pile toe is used because the guided wave would be reflected back and forth from these two edges. The dispersion relation obtained here is related to the pile length and the resonance number, and it would be used to analyze the experimental signal; the experimental dispersion relation can be obtained by this method.

There are two kinds of boundary conditions which can be used for the resonance frequency analysis of the response collected on the pile: the displacement control boundary condition and the stress control boundary condition [27]. The displacement control boundary condition assumes that the displacement at the pile top is not zero but the displacement at the pile toe is zero, that is,

$${u}_{r} ( 0 , t ) = {C}_{0} {e}^{i ω t} + {C}_{0}^{′} {e}^{- i ω t} \qquad ( 17 a )$$

$${u}_{r} ( L , t ) = {C}_{0} {e}^{i ( kL - ω ) t} + {C}_{0}^{′} {e}^{i ( - kL - ω t )} = 0. \qquad ( 17 b )$$

When this boundary condition is considered, the general solution of the displacement uᵣ(z, t) can be expressed as,

$${u}_{r} ( z , t ) = {C}_{a} {e}^{i ω t} \frac{sin [ k ( L - z ) ]}{sin kL} . \qquad ( 18 )$$

in which C₀+C₀=Cₐ. The detail of the derivation process of this solution is given in Appendix C. To satisfy the definition of resonance, the denominator in Equation (18) should approach or equal zero [2], that is, sin kL=0:

$${k}_{n} L = n π , \qquad ( 19 )$$

where n, called resonance number, is a positive integer, i.e., n=1, 2, . . . , N−1, N (N is the total number of the resonance number), and kₙ is the n^{th} resonance wavenumber.

The corresponding n^{th} phase velocity, denoted by

$${v}_{p h , n} = \frac{{ω}_{n}}{{k}_{n}} = 2 π \frac{{f}_{n}}{{k}_{n}} ,$$

can be calculated knowing fₙ and kₙ, where fₙ is the n^{th} resonance frequency (Hz) and ωₙ=2πfₙ (ωₙ is the n^{th} angular frequency (rad/s)). Combined with Equation (19), the phase velocity can be expressed by the pile length L, the resonance number n and its corresponding resonance frequency fₙ, as follows:

$${v}_{ph , n} = 2 L \frac{{f}_{n}}{n} , \qquad ( 20 )$$

which shows the relation between the phase velocity at the resonance frequency using the displacement control boundary condition.

The stress control boundary condition assumes that the stress at the pile top is not zero and the displacement at the pile toe is zero. Here the stress can be estimated as [27],

$${σ}_{r z} = μ \frac{\partial {u}_{r}}{\partial z} . \qquad ( 21 )$$

Similarly, the general solution of the displacement uᵣ(z, t) for this case can be expressed as (for more details see Appendix C),

$${u}_{r} ( z , t ) = - \frac{{C}_{a}^{′} {e}^{- i ω t}}{μ k} \frac{sin [ k ( L - z ) ]}{cos kL} . \qquad ( 22 )$$

where

$$( {C}_{0} - {C}_{0}^{′} ) = {C}_{a}^{′} / ( i μ k ) .$$

To obtain the resonance data, the denominator in Equation (22) should be set as zero, i.e., cos kL=0. Therefore,

$${k}_{n} L = n π \qquad ( 23 )$$

where n is the resonance number and kₙ is its corresponding resonance wavenumber. Using the same analysis for the displacement control boundary condition, the phase velocity v_{ph,n} at the resonance number n can be expressed as

$${v}_{p h n} = 2 L \frac{{f}_{n}}{n - 1 / 2} , \qquad ( 24 )$$

where L is the pile length and fₙ is the n^{th} resonance frequency (Hz).

The genetic algorithm-based inversion for pile characterization as used in the methods described herein will now be described.

As stated above, the physical properties and geometric properties (L) of an unknown pile may be estimated by an inverse method. The physical property can be the set of (E, ρ, v) (Equation (13)) or the set of (c_{b}, cₛ, cₚ) (Equation (14)). In this section, we take the set of (E, ρ, v) as the example.

The core idea of the inversion method follows three steps: 1) the experimental feature or characteristics can be extracted by the experimental data; 2) a forward model should be built for the featured variables to obtain the corresponding theoretical values. 3) an optimization algorithm should be developed to obtain the featured variables by fitting between the experimental and theoretical values obtained in step 1 and step 2, respectively.

In this disclosure, the experimental feature is the resonance data obtained from the spectrum of the response collected on the test pile. The theoretical feature can be calculated by the forward model built in Equation (13). A GA-based optimization process is presented herewith for the property estimation of the pile including E, ρ, v and L, and the loss function for GA is designed by comparing the experimental and theoretical features.

A genetic algorithm is a method of searching for the optimal solution by simulating the natural evolution process following the thought of survival of the fittest [29]. The basic component of GA includes individuals, population, fitness, the selection operator, the crossover operator, and the mutation operator, where the mutation and crossover operators are also called the reproduction operator. The definition of each component of GA is explained as follows. An individual is a solution of the GA, and it has two types: phenotype and genotype. Phenotype is the expected type of the solution, and genotype is the chromosome which is a binary string to which converted from the number of the phenotype. The process of the conversion from phenotype to genotype is called encoding, and the process of the conversion from genotype to phenotype is called decoding. Generally, the phenotype is encoded to a binary string. For a given variable x in phenotype, where x∈[U₁, U₂] can be converted to a binary string, denoted by b, in genotype, and the number of the bits of b is denoted by N_{b}. One bit in b is called a gene. The range [U₁, U₂] is the searching scope of the variable, where U₁ and U₂ are the low and upper limits of the searching range in phenotype. The relation between the phenotype x and the genotype b can be expressed as:

$$x = {U}_{1} + ( {\sum }_{i = 1}^{{N}_{b}} {b}_{i} * {2}^{i - 1} ) \frac{{U}_{2} - {U}_{1}}{{2}^{{N}_{b} - 1}} \qquad ( 25 )$$

If there are several variables, the chromosome is composed of those variables. Therefore, if the number of variables is Nᵥ, the length of the chromosome is N_{b}*Nᵥ.

The population of GA is composed of a certain number of individuals. If the size of the population is denoted by Pop_size, the number of all the bits in the population is Pop_size*N_{b}*Nᵥ. The population can be regarded as a 2-dimensional array with the shape of Pop_size*(N_{b}*Nᵥ).

The loss function of GA is the objective function or misfit function defined for a certain problem, which indicates how well the input solution performs. Generally, the smaller the fitness function, the better the input solution. The selection operator of GA can be implemented by different methods, and in this disclosure, the tournament selection is used. The procedure of the tournament selection is explained as follows: Step 1) from the population yielded in the last iteration, T_size individuals are randomly selected, where usually the number of selected individuals is T_size=2 or 3, and in this disclosure T_size=3; Step 2) from the selected T_size individuals, the one fitting the fitness function best remains; Step 3) the Step 1 and 2 are repeated until Pop_size individuals are obtained.

The crossover operator can be implemented as follows: Step 1) two individuals yielded from the selection operator are selected randomly; Step 2) the probability of crossover is predefined, which is denoted by P_CROSS, where P_CROSS is between 0.1 and 1.0. A random number δ₁ between 0 and 1 is generated, if P_CROSS is larger than δ, the crossover is conducted in Step 3; otherwise, the two selected individuals in Step 1 are saved directly without crossover, and the operator algorithm goes into Step 4; Step 3) in the two individuals selected in Step 1, the crossover site of the chromosome is chosen randomly. There are the single-point crossover, and the multiple-point crossover (the number of the crossover points is equal to or larger than 2). To reduce the computation time, here the single-point crossover is used. After the single-point crossover site is generated randomly, the crossover is conducted and the two new offspring chromosomes can be obtained by the crossover of the two parent chromosomes randomly selected in Step 1. The two offspring chromosomes are saved, and the operator algorithm goes into Step 4; Step 4) Step 1 to 3 are repeated until Pop_size individuals are obtained. The mutation operator is defined as follows. All the bits in the population yielded from the crossover operator are processed by the following approach. For each chosen bit in the current population, a random number δ₂ is compared with the predefined probability of mutation, denoted by P_MUT, which usually is very small. If δ₂ is greater than P_MUT, the chosen bit remains; otherwise, the chosen bit is flipped, where either 0 is changed to 1, or 1 is changed to 0.

A description of the loss function of the inversion process as used in the method described herein follows.

Because in the forward model of Equation (13), when the physical property of the pile including E, ρ and v is given, the theoretical phase velocity

$${v}_{ph}^{th}$$

at a certain frequency (f) can be calculated. In practice, by observing the spectrum of the response collected on the pile, a series of resonance data (n, fn) can be obtained, in which n is the resonance number and fn is the nth resonance frequency; n=1, 2, . . . , N and N is the length of the resonance data. The experimental phase velocity, denoted by

$${v}_{ph}^{ex} ,$$

can be estimated by the resonance number (n), resonance frequency fₙ the pile length L. The nth resonance experimental phase velocity is denoted by

$${v}_{ph , n}^{ex}$$

and the theoretical phase velocity calculated by the forward model DPR (fₙ, E, ρ, v) in Equation (13) is denoted by

$${v}_{ph , n}^{th} .$$

The experimental and theoretical phase velocity, i.e.,

$${v}_{ph , n}^{ex} and {v}_{ph , n}^{th} ( n = 1 , 2 , … , N )$$

is used for the inversion of pile properties E, ρ, v and L by the GA.

The loss function for pile characterization can be implemented using two methods since there are two approaches to estimating the experimental phase velocity. The experimental phase velocity

$${v}_{ph , n}^{ex}$$

can be estimated by resonance frequency fₙ, resonance number n and pile length L, using Equation (20), when the displacement control boundary condition is taken into consideration;

$${v}_{ph , n}^{ex}$$

can be estimated by Equation (24) when the stress control boundary condition is taken as the assumption for the pile. Therefore, two loss functions can be defined corresponding to Equations (20) and (24) respectively as follows,

$${F}_{d} = \frac{1}{N} {\sum }_{n = 1}^{N} {\vert \frac{DPR ( {f}_{n} , E , ρ , v )}{2 L} - \frac{{f}_{n}}{n} \vert}^{2} \qquad ( 26 a )$$

$${F}_{s} = \frac{1}{N} {\sum }_{n = 1}^{N} {\vert \frac{DPR ( {f}_{n} , E , ρ , v )}{2 L} - \frac{{f}_{n}}{n - 1 / 2} \vert}^{2} \qquad ( 26 b )$$

where F_{d} and Fₛ are the loss functions based on the experimental data and the forward model-generated data using the displacement and stress control boundary condition, respectively. In these loss functions, the term

$$\frac{DPR ( {f}_{n} , E , ρ , v )}{2 L}$$

can be regarded as the theoretical feature and the terms

$$\frac{{f}_{n}}{n} and \frac{{f}_{n}}{n - 1 / 2}$$

can be regarded as the experimental feature. These two kinds of loss functions would be compared for pile characterization in the case study.

Since the stress at the pile top is assumed to be non-zero, the stress control boundary condition-based loss function is suggested when the pile top is not in service, such as supporting a superstructure. Since the displacement at the pile top is assumed to be non-zero, the displacement control boundary condition-based loss function is suggested when the pile top is a free end (no superstructure connected to), whose displacement is larger compared to a pile top connected to a superstructure.

A description of the inversion process based on GA for pile characterization as used in the method described herein follows.

Based on the loss function F_{d} and Fₛ defined in Equations (26), and in the optimization process of GA, L, E, ρ and v are used as variables. The schematic diagram of the inversion process based on GA has been shown in FIG. 1(c), and the detail of the algorithm based on GA is given in Algorithm 1.

Those variables can be initialized randomly, and the initial values, denoted by L₀, E₀, ρ₀ and v₀ can be set in a certain range [U₁, U₂], respectively. For each variable, the low limit U₁ and the upper limit U₂ of the range can be chosen by the prior knowledge of the property of the test pile. Each decimal variable can be transferred to the binary string and a chromosome can be generated by those binary strings of these variables. When the population size Pop_size and the number of the bits for each variable are set, the initial population formed by Nᵥ*N_{b}*Pop_size can be determined. Then the variable updating process is iterated, and the loss function proposed in Equation (26) is used for the optimization, and the vector F is used to record the loss function value (using either Fₛ or F_{d}) at different iteration number i. During the iteration, the selection, crossover and mutation operators are used for the variable updating of the population in genotype and the forward model DPR(fₙ, E, ρ, v) and the pile length L are used to give the theoretical feature for the loss function calculation using the initial or the updated variables. When the algorithm is converged or the iteration number i reaches the pre-defined maximum iteration number of the optimization process, denoted by Iter_No_Max, the algorithm is ceased and the optimized variables L*, E*, ρ*, v* and the loss function record F can be output. The configuration parameters of GA used in this disclosure are summarized in Table 1.

Algorithm 1 GA-based optimization of the inversion process for pile characterization

```
Initialization: L = L₀, E = E₀, ρ = ρ₀, v₀ = v, i = 1, Iter_No_Max, Pop_size, N_{b}, Nᵥ,
T_size, P_CROSS, P_MUT
while i ≤ Iter_No_Max do
    $Loss F [ i ] : {F}_{d} = \frac{1}{N} {\sum }_{n = 1}^{N} {\vert \frac{DPR ( {f}_{n} , E , ρ , v )}{2 L} - \frac{\text{?}}{\text{?}} \vert}^{2} or {F}_{s} = \frac{1}{N} {\sum }_{n = 1}^{N} {\vert \frac{DPR ( {f}_{n} , E , ρ , v )}{2 L} - \frac{f \text{?}}{n - \frac{1}{2}} \vert}^{2}$
    Selection: using T_size
    Crossover: using P_CROSS
    Mutation: using P_MUT
    Forward model: DPR(f [symbol]  , E, ρ, v)
    i + +
end while
Output the inversely estimated variables: L*, E*, ρ*, v* and the loss function record F. [symbol]
indicates data missing or illegible when filed
```

TABLE 1
The configuration parameter of GA

| Parameters | Value |
|---|---|
| Population size (Pop_size) | 20 |
| The number of bits (N_{b}) | 10 |
| The number of variables (Nᵥ) | 4 |
| Tournament size (T_size) | 3 |
| The probability of crossover (P_CROSS) | 0.90 |
| The probability of mutation (P_MUT) | 0.05 |

To validate the effectiveness and the accuracy of the method described herein, the experimental data provided by Wang and Wang is used. The signal from one sensor placed on the lateral side of the test pile is used. The pile is impacted on the lateral side by a handheld model hammer. This pile is under a traction-free condition and its physical and geometric properties are summarized in Table 2.

TABLE 2
The physical and geometric properties of the test pile

| Parameters (Unit) | Values |
|---|---|
| The bar velocity, c_{b} (m/s) | 3711.5 |
| Poisson's ratio, v | 0.2 |
| The pile length, L (m) | 3.763 |
| The length of the embedded part, Lₑₘ (m) | 1.9 |
| The radius of the pile, r(m) | 0.1245 |

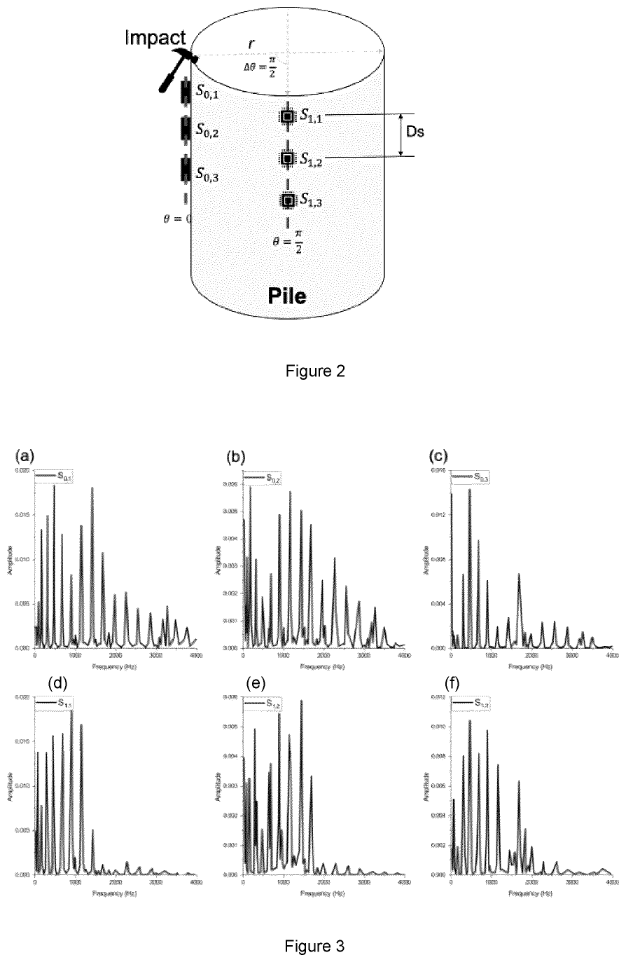

The schematic diagram of the positions of signal acquisition is shown in FIG. 2. Those positions are arranged on two lines on the lateral side of the test pile 12: the line θ=0 and the line

$$θ = \frac{π}{2} ,$$

where θ is the angle between the impact line and the sensor line. In each of these two lines, three positions are selected for data acquisition, and the distance between two adjacent positions in each line is denoted by Dₛ and here Dₛ=0.25 m. Along the line θ=0, three positions are denoted by S_{0,1}, S_{0,2} and S_{0,3}, respectively, and the highest position i.e. S_{0,1} is placed at the top periphery of the pile, where the impact is also applied. Along the line

$$θ = \frac{π}{2} ,$$

three positions are denoted by S_{1,0}, S_{1,2} and S_{1,3}, respectively, and the highest position, i.e., S_{1,1}, is placed at the top periphery of the pile. The signal acquired in this disclosure is the acceleration and hence 6 individual vibration signals are collected. These 6 signals are used for the pile characterization in this method.

When the vibration signal is recorded, according to the method in FIG. 1(b), the response in the time domain can be transferred into the frequency domain. The spectrum of these 6 signals is shown in FIGS. 3a-f. According to the spectrum of these 6 signals, the resonance number and the resonance frequency at each resonance number can be identified. The detail of the resonance data identified from the spectrum of each signal can be found in Wang and Wang [26]. The resonance number and resonance frequency identified from each spectrum are summarized in Table D.4. In each spectrum, the resonance frequency f₁ (i.e., at the resonance number n=1) cannot be identified. In the spectrum of S_{0,3}, the total number of resonance numbers is N=16, and for other signals is N=17. Therefore, in each spectrum, the resonance data (n, fₙ) (n=2, 3, . . . , N), can be obtained for the inversion of pile properties.

According to Equations (20) and (24), the experimental phase velocity can be calculated for the two types of boundary conditions, respectively, using the resonance data (displayed in Table D.4) when the pile length L is known. If the pile property is also known (given in Table 2), the theoretical phase velocity at the resonance frequency identified in the spectrum of the vibration signal (shown in Table D.4) can also be calculated using the forward model (Equation (14)). For each signal, the theoretical phase velocity, the experimental phase velocity based on the displacement control boundary condition, and the experimental phase velocity based on the stress control boundary condition are shown in FIGS. 4a-f.

From FIGS. 4a-f, it can be observed that the theoretical phase velocity fits well with the experimental phase velocity based on the two different boundary conditions; the experimental data based on the stress control boundary condition fits better with the theoretical model in this case. To further validate the performance of the experimental data obtained by those two different boundary conditions, both of them are used for the inversion of pile characterization.

According to the resonance data given in Table D.4, the optimization based on GA is conducted for the variable inversion, in which the loss function (Equation (26)) is defined for different boundary conditions. The searching range for each variable of GA is shown in Table 3. In one example, calculation is performed by the computer 22, and the inversion takes approximately 30 minutes if Iter_No_Max is set as 20.

TABLE 3
The searching range of the variable in GA

| Parameters (Unit) | The searching range |
|---|---|
| The bar velocity, c_{b} (km/s) | 3.0, 4.5] |
| Poisson's ratio, v | 0.15, 0.25] |
| The pile length, L (m) | 2.5, 4.5] |

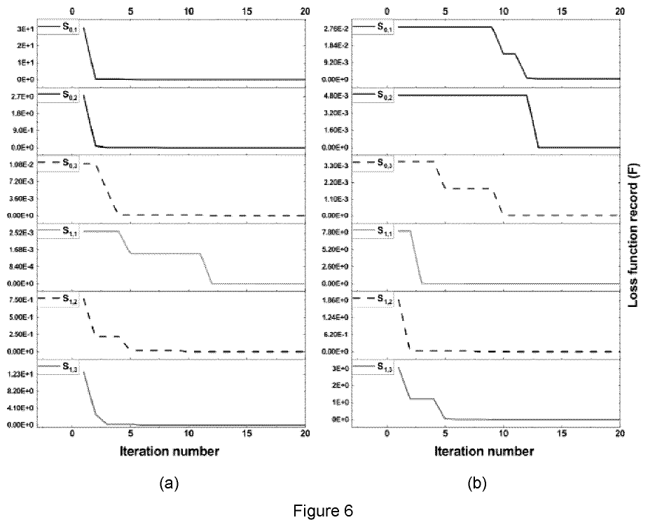

The inversion result can be obtained when GA reaches its convergence. According to Equation (6), the shear wave velocity (cₛ) and the longitudinal wave velocity (cₚ) can be calculated by the bar velocity (c_{b}) and Poisson's ratio (v). The absolute error rate of the inverse estimation for c_{b}, cₛ and cₚ and the pile length Z using each signal is shown in FIGS. 5a-f, where the result of loss function Fₛ and F_{d} is compared. It can be concluded that 1) the inversion method presented in this disclosure using the guided wave theory and GA is effective for the inversion of the pile property; 2) the loss function based on the displacement and the stress control boundary condition can be used for pile characterization; 3) the fitness defined for the stress control boundary condition performs better than the loss function defined for the displacement control boundary condition in this case. Therefore, in this case, this loss function Fₛ is suggested for pile property characterization in practice. The loss function value at different iterations, record (F), of GA for different signals based on the loss function Fₛ and F_{d} is summarized in FIGS. 6a-b; it gives the loss function record of each signal, which shows GA reaches its convergence, respectively.

In another implementation, the robustness of the inversion algorithm and the acceleration of the traditional GA is enhanced for greater accuracy.

In another implementation, the inversion process for pile characterization is extended to the longitudinal mode of the guided wave model.

FIG. 7 illustrates a block diagram of an example of a machine 22 upon which any one or more of the techniques (e.g., methodologies) discussed herein can perform. In alternative embodiments, the machine 22 can operate as a standalone device or are connected (e.g., networked) to other machines. In a networked deployment, the machine 22 can operate in the capacity of a server machine, a client machine, or both in server-client network environments. In an example, the machine 22 can act as a peer machine in peer-to-peer (P2P) (or other distributed) network environment. The machine 22 is a personal computer (PC), a tablet PC, a set-top box (STB), a personal digital assistant (PDA), a mobile telephone, a smart phone, a web appliance, a network router, switch or bridge, a server computer, a database, conference room equipment, or any machine capable of executing instructions (sequential or otherwise) that specify actions to be taken by that machine. In various embodiments, machine 22 can perform one or more of the processes described above. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, can include, or can operate on, logic or a number of components, modules, or mechanisms (all referred to hereinafter as “modules”). Modules are tangible entities (e.g., hardware) capable of performing specified operations and is configured or arranged in a certain manner. In an example, circuits are arranged (e.g., internally or with respect to external entities such as other circuits) in a specified manner as a module. In an example, the whole or part of one or more computer systems (e.g., a standalone, client or server computer system) or one or more hardware processors are configured by firmware or software (e.g., instructions, an application portion, or an application) as a module that operates to perform specified operations. In an example, the software can reside on a non-transitory computer readable storage medium or other machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor is configured as respective different modules at different times. Software can accordingly configure a hardware processor, for example, to constitute a particular module at one instance of time and to constitute a different module at a different instance of time.

Machine 22 can include a hardware processor 202 (e.g., a central processing unit (CPU), a graphics processing unit (GPU), a hardware processor core, or any combination thereof), a main memory 204, and a static memory 206, some or all of which can communicate with each other via an interlink 208 (e.g., bus). The machine 22 can further include a display unit 210, an alphanumeric input device 212 (e.g., a keyboard), and a user interface (UI) navigation device 214 (e.g., a mouse). In an example, the display unit 210, input device 212 and UI navigation device 214 are a touch screen display. The machine 22 can additionally include a storage device (e.g., drive unit) 216, a signal generation device 218 (e.g., a speaker), a network interface device 220, and one or more sensors 20, such as an accelerometer, or other sensor. The machine 22 can include an output controller 228, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 can include a machine readable medium 222 on which is stored one or more sets of data structures or instructions 224 (e.g., software) embodying or utilized by any one or more of the techniques or functions described herein. The instructions 224 can also reside, completely or at least partially, within the main memory 204, within static memory 206, or within the hardware processor 202 during execution thereof by the machine 22. In an example, one or any combination of the hardware processor 202, the main memory 204, the static memory 206, or the storage device 216 can constitute machine readable media. While the machine readable medium 222 is illustrated as a single medium, the term “machine readable medium” can include a single medium or multiple media (e.g., a centralized or distributed database, and/or associated caches and servers) configured to store the one or more instructions 224.

The term “machine readable medium” can include any medium that is capable of storing, encoding, or carrying instructions for execution by the machine 22 and that cause the machine 22 to perform any one or more of the techniques of the present disclosure, or that is capable of storing, encoding or carrying data structures used by or associated with such instructions. Nonlimiting machine-readable medium examples can include solid-state memories, and optical and magnetic media. Specific examples of machine-readable media can include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media can include non-transitory machine-readable media. In some examples, machine readable media can include machine readable media that is not a transitory propagating signal.

The instructions 224 can further be transmitted or received over a communications network 226 using a transmission medium via the network interface device 220. The machine 22 can communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 602.11 family of standards known as Wi-Fi®, IEEE 602.16 family of standards known as WiMax®), IEEE 602.15.4 family of standards, a Long Term Evolution (LTE) family of standards, a Universal Mobile Telecommunications System (UMTS) family of standards, peer-to-peer (P2P) networks, among others. In an example, the network interface device 220 can include one or more physical jacks (e.g., Ethernet, coaxial, or phonejacks) or one or more antennas to connect to the communications network 226. In an example, the network interface device 220 can include a plurality of antennas to wirelessly communicate using at least one of single-input multiple-output (SIMO), multiple-input multiple-output (MIMO), or multiple-input single-output (MISO) techniques. In some examples, the network interface device 220 can wirelessly communicate using Multiple User MIMO techniques.

Examples, as described herein, can include, or can operate on, logic or a number of components, modules, or mechanisms. Modules are tangible entities (e.g., hardware) capable of performing specified operations and are configured or arranged in a certain manner. In an example, circuits are arranged (e.g., internally or with respect to external entities such as other circuits) in a specified manner as a module. In an example, the whole or part of one or more computer systems (e.g., a standalone, client, or server computer system) or one or more hardware processors are configured by firmware or software (e.g., instructions, an application portion, or an application) as a module that operates to perform specified operations. In an example, the software can reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor is configured as respective different modules at different times. Software can accordingly configure a hardware processor, for example, to constitute a particular module at one instance of time and to constitute a different module at a different instance of time.

Various embodiments are implemented fully or partially in software and/or firmware. This software and/or firmware can take the form of instructions contained in or on a non-transitory computer-readable storage medium. Those instructions can then be read and executed by one or more processors to enable performance of the operations described herein. The instructions are in any suitable form, such as but not limited to source code, compiled code, interpreted code, executable code, static code, dynamic code, and the like. Such a computer-readable medium can include any tangible non-transitory medium for storing information in a form readable by one or more computers, such as but not limited to read only memory (ROM); random access memory (RAM); magnetic disk storage media; optical storage media; flash memory; etc.

Each of the non-limiting aspects or examples described herein can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code can form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact discs and digital video discs), magnetic cassettes, memory cards or sticks, random access memories (RAMs), read only memories (ROMs), and the like.

The above description is intended to be illustrative, and not restrictive. For example, the above-described examples (or one or more aspects thereof) can be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can be in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

### Appendix A. The Derivation Process of Potentials of Helmholtz's Decomposition

Equations (9) can be substituted into Equations (5) and Equations (8), and then for each equation in Equations (9), two independent ordinary equations (ODEs) can be obtained [10]. For example, in Equation (9a), the ODEs related to f_{φ}(r) and Θ_{φ}(θ) are,

$$\frac{{d}^{2} {Θ}_{ϕ} ( θ )}{d {θ}^{2}} + {ξ}^{2} {Θ}_{ϕ} ( θ ) = 0 , \qquad ( A \text{.1} a )$$

$$\frac{{d}^{2} {f}_{ϕ} ( r )}{{dr}^{2}} + \frac{1}{r} \frac{{df}_{ϕ} ( r )}{dr} + ( \frac{{ω}^{2}}{{c}_{p}^{2}} - {k}^{2} - \frac{{ξ}^{2}}{{r}^{2}} ) {f}_{ϕ} ( r ) = 0 , \qquad ( A \text{.1} b )$$

in which ξ is a non-negative integer, which is called the circumferential order. The general solution of Equation (A.1a) can be expressed as,

$${Θ}_{ϕ} ( θ ) = {A}_{1} sin ξθ + {A}_{2} cos ξθ , \qquad ( A \text{.2} )$$

where A₁ and A₂ are the arbitrary coefficients. Similarly, Θᵣ(θ), Θ_{θ}(θ) and Θ_{z}(θ) of

Equations (9b, 9c) and (9d) can also be obtained. Because there are the longitudinal mode (symmetric model) or the flexural mode (asymmetric mode), either sine or cosine terms in the expressions for Θ_{φ}(θ), Θᵣ(θ), Θ_{θ}(θ) and Θ_{z}(θ) should be removed to indicate the different mode. Therefore, φ, ψᵣ, ψ_{θ}, ψ_{z} can be expressed as,

$$ϕ = {f}_{ϕ} ( r ) cos ξθ {e}^{i ( kz - ω t )} , \qquad ( A \text{.3} a )$$

$${ψ}_{z} = {h}_{z} ( r ) sin ξθ {e}^{i ( kz - ω t )} . \qquad ( A \text{.3} b )$$

$${ψ}_{r} = {h}_{r} ( r ) sin ξθ {e}^{i ( kz - ω t )} , \qquad ( A \text{.3} c )$$

$${ψ}_{θ} = {h}_{θ} ( r ) cos ξθ {e}^{i ( kz - ω t )} , \qquad ( A \text{.3} d )$$

According to the definition of the Bessel function, the general solution for Equation (A.1b) can be expressed as

$${f}_{ϕ} , ( r ) = {A}_{3} {J}_{ξ} ( {k}_{p} r ) + {A}_{4} {Y}_{ξ} ( {k}_{p} r ) , \qquad ( A \text{.4} )$$

where J_{ξ}(⋅) is the first kind Bessel function of the order ξ, and Y_{ξ}(⋅) is the second kind Bessel functions of the order ξ; A₃ and A₄ are the arbitrary coefficients. Because at the position of origin (r=0) the response is finite, but the term with Y_{ξ}(⋅) is infinite, the second term in Equations (A.4) should be removed. Therefore, f_{φ}(r) can be estimated as,

$${f}_{ϕ} ( r ) = {A}_{3} {J}_{ξ} ( {k}_{p} r ) . \qquad ( A \text{.5} )$$

Similarly, the solution of h_{z}(r) in Equation (A.3b) can be obtained as,

$${h}_{z} ( r ) = {B}_{3} {J}_{ξ} ( {k}_{s} r ) . \qquad ( A \text{.6} )$$

Here the wavenumber of the longitudinal wave kp, and the wavenumber of the shear wave kₛ are defined, respectively, as,

$${k}_{p}^{2} = ( \frac{{ω}^{2}}{{c}_{p}^{2}} - {ω}^{2} ) , \qquad ( A \text{.7} a )$$

$${k}_{s}^{2} = ( \frac{{ω}^{2}}{{c}_{s}^{2}} - {ω}^{2} ) . \qquad ( A \text{.7} b )$$

When ψᵣ and ψ_{θ} in Equations (A.3c) and (A.3d) are substituted into Equations (8a) and (8b), respectively, the following equations can be obtained as Equations (A.8) and (A.9),

$$\frac{{d}^{2} {h}_{r} ( r )}{{dr}^{2}} + \frac{1}{r} \frac{{dh}_{r} ( r )}{dr} + \frac{1}{{r}^{2}} [ - {ξ}^{2} {h}_{r} ( r ) + 2 ξ {h}_{θ} ( r ) - {h}_{r} ( r ) ] - {k}_{s}^{2} {h}_{r} ( r ) = 0 , \qquad ( A \text{.8} )$$

$$\frac{{d}^{2} {h}_{θ} ( r )}{{dr}^{2}} + \frac{1}{r} \frac{{dh}_{θ} ( r )}{dr} + \frac{1}{{r}^{2}} [ - {ξ}^{2} {h}_{θ} ( r ) + 2 ξ {h}_{r} ( r ) - {h}_{θ} ( r ) ] - {k}_{s}^{2} {h}_{θ} ( r ) = 0 , \qquad ( A \text{.9} )$$

By subtracting Equation (A.9) from Equation (A.8), we can obtain,

$$[ \frac{{d}^{2}}{d {r}^{2}} + \frac{1}{r} \frac{d}{dr} + \frac{{( 1 + ξ )}^{2}}{{r}^{2}} - {k}_{s}^{2} ] [ {h}_{r} ( r ) - {h}_{θ} ( r ) ] = 0 , \qquad ( A \text{.10} )$$

for which the following solution can be derived,

$${h}_{r} ( r ) - {h}_{θ} ( r ) = 2 {C}_{1} {J}_{ξ + 1} ( {k}_{s} r ) , \qquad ( A \text{.11} )$$

where C₁ is an arbitrary coefficient. Similarly, by addition of Equations (A.9) and (A.8), we obtain,

$${h}_{r} ( r ) + {h}_{θ} ( r ) = 2 {C}_{2} {J}_{ξ - 1} ( {k}_{s} r ) , \qquad ( A \text{.12} )$$

where C₂ is an arbitrary coefficient.

According to Equations (A.11) and (A.12), the potential functions hᵣ(r) and h_{θ}(r) can be obtained,

$${h}_{r} ( r ) = {C}_{2} {J}_{ξ - 1} ( {k}_{s} r ) + {C}_{1} {J}_{ξ + 1} ( {k}_{s} r ) , \qquad ( A \text{.13} a )$$

$${h}_{θ} ( r ) = {C}_{2} {J}_{ξ - 1} ( {k}_{s} r ) - {C}_{1} {J}_{ξ + 1} ( {k}_{s} r ) , \qquad ( A \text{.13} b )$$

According to the Gauge condition (Equation (4)), we can deduce that hᵣ(r)=−h_{θ}(r). Therefore, in Equation (A.13), the coefficient C₂ should be set as 0. Accordingly, the potentials φ, ψᵣ, ψ_{θ} and ψ_{z} can be summarized as Equation (10).

### Appendix B. The Components of the Matrix M

The components of the 3×3 matrix M are given as follows:

$$M ( 1 , 1 ) = \frac{\text{?}}{{r}^{2}}$$

$$M ( 1 , 2 ) = \frac{\text{?}}{r}$$

$$M ( 1 , 3 ) = \frac{\text{?}}{\text{?}}$$

$$M ( 2 , 1 ) = \frac{\text{?}}{r}$$

$$M ( 2 , 2 ) = \frac{\text{?}}{{r}^{2}}$$

$$M ( 2 , 3 ) = \frac{\text{?}}{\text{?}}$$

$$M ( 3 , 1 ) = \frac{\text{?}}{r}$$

$$M ( 3 , 2 ) = \frac{\text{?}}{r}$$

$$M ( 3 , 3 ) = - μ \frac{\text{?}}{2}$$

$$\text{?} \text{indicates text missing or illegible when filed}$$

### Appendix C. The Derivation Process of Resonance Analysis Using the Guided Wave Model-Based Displacement

### Appendix C.1. Resonance Analysis Using the Displacement Control Boundary Condition

The Cₐ is defined as,

$${C}_{O} + {C}_{0}^{‵} = {C}_{a} , \qquad ( C \text{.1} )$$

and since we assume uᵣ(z, t)=0 and according to Equation (17b), we obtain:

$${C}_{0} {e}^{i ( k L - ω t )} + {C}_{0}^{‵} {e}^{i ( - k L - ω t )} = 0. \qquad ( C \text{.2} )$$

Based on Equations (C.1) and (C.2), the coefficients C₀ and

$${C}_{0}^{′}$$

can be determined as,

$${C}_{0} = \frac{{C}_{a}}{1 - {e}^{2 ikL}} \qquad ( C \text{.3} a )$$

$${C}_{0}^{‵} = \frac{{C}_{a}}{1 - {e}^{- 2 ikL}} \qquad ( C \text{.3} b )$$

Substituting Equations (C.3) into Equation (16), we can obtain,

$${u}_{r} ( z , t ) = {C}_{a} {e}^{- i ( ω t )} \frac{{e}^{k z \dot{ι}} {e}^{- k L \dot{ι}} - {e}^{- k z \dot{ι}} {e}^{kL \dot{ι}}}{{e}^{- \dot{ι} k L} - {e}^{kLi}} \qquad ( C \text{.4} )$$

According to Euler's formula, i.e., e^{ix}=cos x+i sin x (x is the variable), in Equation (C.4), the term (e^{kzi}e^{-kLi}−e^{-kzi}e^{kLi}) can be expanded and then simplified by the trigonometric function property,

$${e}^{kzi} {e}^{- k L i} - {e}^{- k z i} {e}^{k L i} = - 2 i ( sin kL cos kz - cos kL sin kz ) = - 2 i sin [ k ( L - z ) ] . \qquad ( C \text{.5} )$$

In Equation (C.4), the term (e^{-kLi}−e^{kLi}) can be expanded and then simplified as,

$${e}^{- k L i} - {e}^{k L i} = - 2 i sin ( kL ) \qquad ( C \text{.6} )$$

Substituting Equations (C.5) and (C.6) into Equation (C.4), the solution of uᵣ can be simplified as,

$${u}_{\text{?}} ( z , t ) = {C}_{\text{?}} {e}^{\text{?}} \frac{sin [ k ( L - z ) ]}{sin ( kL )} \qquad ( C \text{.7} )$$

$$\text{?} \text{indicates text missing or illegible when filed}$$

### Appendix C.2. Resonance Analysis Using the Stress Control Boundary Condition

According to Equations (16) and (21), the stress σ_{rz} can be obtained as,

$${σ}_{r z} = i k μ [ {C}_{0} {e}^{i ( k L - ω t )} - {C}_{0}^{′} {e}^{i ( - k L - ω t )} ] \qquad ( C \text{.8} )$$

According to the stress control boundary condition, at the top of the pile, the stress is not equal to zero, i.e, σ_{rz}(0,t)≠0:

$${σ}_{r z} ( 0 , t ) = i μ k {e}^{- i ω t} ( {C}_{0} - {C}_{0}^{′} ) \qquad ( C \text{.9} )$$

We can assume that,

$$i μ k ( {C}_{0} - {C}_{0}^{′} ) = {C}_{a}^{′} , \qquad ( C \text{.10} )$$

and according to the stress control boundary condition at the toe of the pile, the displacement is also regarded as zero, as shown in Equation (17b).

Therefore, according to Equations (17b) and (C.10), the coefficients C₀ and

$${C}_{0}^{′}$$

can be determined as,

$${C}_{0} = \frac{{C}_{a}^{′} / ( i μ k )}{1 + {e}^{2 kLi}} , \qquad ( C \text{.11} a )$$

$${C}_{0}^{′} = - \frac{{C}_{a}^{′} / ( i μ k )}{1 + {e}^{- 2 kLi}} , \qquad ( C \text{.11} b )$$

Substituting Equation (C.11) into Equation (16), then we can obtain,

$${u}_{r} ( z , t ) = {C}_{a}^{′} / ( i μ k ) {e}^{- i ( ω t )} \frac{{e}^{k z \dot{ι}} {e}^{- kLi} - {e}^{- kzi} {e}^{kLi}}{{e}^{- ikL} ∓ {e}^{kLi}} \qquad ( C \text{.12} )$$

Similarly, Euler's formula is used to expand the equation for further simplification. The term (e^{kzi}e^{-kLi}−e^{-kzi}e^{kLi}) has been simplified in Equation (C.5), and the term (e^{-kLi}+e^{kLi}) can be expanded and then simplified as,

$${e}^{- k L i} + {e}^{k L i} = 2 cos ( kL ) . \qquad ( C \text{.13} )$$

Substituting Equations (C.5) and (C.13) into Equation (C.12), the solution of uᵣ can be simplified as,

$${u}_{r} ( z , t ) = - {C}_{a}^{′} / ( μ k ) {e}^{- i ( ω t )} \frac{sin [ k ( L - z ) ]}{cos kL} \qquad ( C \text{.14} )$$

### Appendix D. The Resonance Data

Table D.4: The resonance number and resonance frequency identified from the spectrum of the 6 vibration signals provided by Wang and Wang [26].

| Resonance | Resonance frequency fₙ (Hz) | | | | | |
|---|---|---|---|---|---|---|
| number(n) | S_{0, 1} | S_{0, 2} | S_{0, 3} | S_{1, 1} | S_{1, 2} | S_{1, 3} |
| 1 | NI | NI | NI | NI | NI | NI |
| 2 | 68 | 68 | 68 | 60 | 60 | 60 |
| 3 | 154 | 154 | 154 | 146 | 146 | 146 |
| 4 | 291 | 291 | 291 | 291 | 291 | 291 |
| 5 | 454 | 454 | 454 | 454 | 454 | 454 |
| 6 | 659 | 659 | 659 | 659 | 659 | 659 |
| 7 | 882 | 882 | 882 | 882 | 882 | 882 |
| 8 | 1,139 | 1,139 | 1,139 | 1,139 | 1,139 | 1,139 |
| 9 | 1,404 | 1,404 | 1,404 | 1,404 | 1,404 | 1,404 |
| 10 | 1,661 | 1,661 | 1,661 | 1,661 | 1,661 | 1,661 |
| 11 | 1,952 | 1,952 | 1,952 | 1,969 | 1,961 | 1,969 |
| 12 | 2,243 | 2,243 | 2,243 | 2,260 | 2,260 | 2,260 |
| 13 | 2,543 | 2,543 | 2,543 | 2,560 | 2,560 | 2,560 |
| 14 | 2,851 | 2,851 | 2,851 | 2,860 | 2,860 | 2,860 |
| 15 | 3,159 | 3,159 | 3,159 | 3,176 | 3,176 | 3,176 |
| 16 | 3,476 | 3,485 | 3,476 | 3,476 | 3,476 | 3,476 |
| 17 | 3,750 | 3,767 | NI | 3,767 | 3,767 | 3,776 |

Note:
NI means not identified.

### REFERENCES

[1] D. Basu, A. Misra, and A. J. Puppala. Sustainability and geotechnical engineering: perspectives and review. Canadian geotechnical journal, 52(1):96-113, 2015.
[2] A. Bedford and D. S. Drumheller. Elastic wave propagation. John Wiley & Sons, 1994.
[3] A. P. Butcher, J. J. M. Powell, and H. D. Skinner. Whole life cost and environment impact case studies. Reuse of foundations for urban sites: A best practice handbook, IHS BRE Press, Berkshire, United Kingdom, pages 116-119, 2006.
[4] H. Chao. An experimental model for non-destructive evaluation on pile foundations using guided wave approach. PhD thesis, Northwestern University, 2002.
[5] S. Cui and P. Maghoul. A single-sensor system for length estimation of unknown piles using guided waves (under review). 2022.
[6] S. Cui, H. Liu, and P. Maghoul. Pile length estimation based on guided wave theory and dispersion analysis for reuse of foundations (under review). 2022.
[7] R. A. Douglas, J. L. Eddy, and H. E. Wahls. On transforms and the dispersion computations used for evaluating layer properties. ASTM special technical publications, pages 612-627, 1989.
[8] S. Du, D. Li, and Y. Chen. The study of the quantity of wave speed in low strain integrity testing of foundation pile. In Applied Mechanics and Materials, volume 170, pages 77-82. Trans Tech Publications, 2012.
[9] A. T. M. Farid. Prediction of unknown deep foundation lengths using the hilbert huang transform (hht). HBRC Journal, 8(2):123-131, 2012. ISSN 1687-4048.
[10] A. A. Feruza. Dispersion relations for elastic waves in plates and rods. Master's thesis, The State University of New Jersey, 2011.
[11] R. J. Finho and H. Chao. Guided waves in embedded concrete piles. Journal of Geotechnical and Geoenvironmental Engineering, 131:11-19, January 2005.
[12] R. J. Finno, J. S. Popovics, A. A. Hanifah, W. L. Kath, H. Chao, and Y. Hu. Guided wave interpretation of surface reflection techniques for deep foundations. Italian Geotechnical Journal, 35(1):76-91, 2001.
[13] B. He, Y. Lai, L. Wang, Y. Hong, and R. Zhu. Scour effects on the lateral behavior of a large-diameter monopile in soft clay: Role of stress history. Journal of Marine Science and Engineering, 2019.
[14] J. A. Holt, S. Chen, and R. A. Douglas. Determining length of installed timber pilings by dispersive wave propagation. Transportation Research Record, pages 110-115, 1994.
[15] B. J. Jozi, U. Dackermann, R. B. Braun, J. Li, and B. S. Samali. Application and improvement of conventional stress-wave-based non-destructive testing methods for the condition assessment of in-service timber utility poles. In Australasian Conference on the Mechanics of Structures and Materials. Southern Cross University, 2014.
[16] J. Li, M. Subhani, and B. Samali. Determination of embedment depth of timber poles and piles using wavelet transform. Advances in Structural Engineering, 15(5):759-770, 2012. doi: 10.1260/1369-4332. 15.5.759.
[17] Y. Lin, M. Sansalone, and N. J. Carino. Impact-echo response of concrete shafts. Geotechnical Testing Journal, 14:121-137, 1991.
[18] H. Liu, P. Maghoul, A. Shalaby, A. Bahari, and F. Moradi. Integrated approach for the masw dispersion analysis using the spectral element technique and trust region reflective method. Computers and Geotechnics, 125:103689, 2020.
[19] H. Liu, P. Maghoul, G. Mantelet, and A. Shalaby. Geondt: a fast general-purpose computational tool for geotechnical non-destructive testing applications. Acta Geotechnica, pages 1-20, 2022.
[20] A. H. Meitzler. Mode coupling occurring in the propagation of elastic pulses in wires. The Journal of the Acoustical Society of America, 33(4):435-445, 1961.
[21] V. Samu and M. Guddati. Nondestructive method for length estimation of pile foundations through effective dispersion analysis of reflections. Journal of Nondestructive Evaluation, 38(2):1-11, 2019.
[22] V. Samu and M. Guddati. Nondestructive length estimation of an embedded pile through combined analysis of transverse and longitudinal waves. NDT & E International, 110:102203, 2020.
[23] M. Subhani, J. Li, B. Samali, and N. Yan. Determination of the embedded lengths of electricity timber poles utilising flexural wave generated from impacts. Australian Journal of Structural Engineering, 14(1):85-96, 2013. doi: 10.7158/S12-047.2013.14.1.
[24] K. T. Tran, F. Jalinoos, and A. K. Agrawal. Characterization of concrete pile groups with 2-d seismic waveform tomography. Journal of Nondestructive Evaluation, 38(1), 2019. doi: 10.1007/s10921-019-0565-x.
[25] H. Wang. Pile length estimate of impulse response testing with guided wave approach. Experimental Techniques, 44(5):625-637, 2020.
[26] H. Wang and C. Wang. Flexural wave impulse response evaluations of piles using multiple triaxial accelerometers. In Stress Wave Theory and Testing Methods for Deep Foundations: 10th International Conference, ASTM STP1611, pages 254-272. ASTM International, West Conshohocken, PA, 2019.
[27] H. Wang, T. Chang, and J. Wang. Response analysis of concrete piles subjected to lateral impact. Journal of Marine Science and Technology, 18(6):9, 2010.
[28] B. Wrana. Pile load capacity—calculation methods. Studia Geotechnica et Mechanica, 37, December 2015.
[29] X. Yang. Chapter 6-genetic algorithms. In Xin-She Yang, editor, Nature-Inspired Optimization Algorithms (Second Edition), pages 91-100. Academic Press, second edition, 2021. ISBN 978-0-12-821986-7.
[30] C. Yu. Evaluation of pile lengths using impact-induced flexural vibrations-a frequency domain approach. NDT & E International, 108:102174, 2019.

1. A computerized method for determining a value of at least one characteristic of a structure having a buried portion and a non-buried portion, the method comprising the steps of:
impacting the structure on a lateral side of the non-buried portion to cause an excitation within the structure;
acquiring an excitation response signal with a receiver placed on the lateral side of the non-buried portion and generating excitation response data;
determining a resonance number and a resonance frequency from the excitation response data; performing an inversion process based on guided wave theory and a genetic algorithm to determine the value of the at least one characteristic of the structure.

2. The method of claim 1, wherein the value of the at least one characteristic of the structure is associated with at least one of a mechanical property and a geometric property.

3. The method of claim 2, wherein the mechanical property is at least one of a Young's modulus (E), density (ρ), and Poisson's ratio (v)) and the geometric property is length (L)) of the structure.

4. The method of claim 1, further comprising generating a forward model associated with the at least one feature value associated with the at least one characteristic to obtain a corresponding at least one theoretical feature value associated with the at least one characteristic.

5. The method of claim 4, further comprising estimating, at the data processing apparatus, at least one feature variable using an inverse method based on the resonance data and at least one theoretical feature value.

6. The method of claim 5, wherein the at least one characteristic of a structure is determined automatically.

7. The method of claim 6, wherein the at least one characteristic of a structure is determined automatically by applying at least one non-destructive testing (NDT) modality to the structure.

8. The method of claim 4, further comprising a machine including a processor, a computer readable medium having instructions stored thereon, the instructions executable by the processor to estimate the at least one of a mechanical property and a geometric property of the structure, wherein the instructions are based on a guided wave model and a genetic algorithm model for optimization.

9. The method of claim 8, further comprising a step of performing a loss function, wherein a loss function value is recorded.

10. The method of claim 9, wherein the loss function Fd is defined as
$${F}_{d} = \frac{1}{N} {\sum }_{n = 1}^{N} {\vert \frac{D PR ( {f}_{n} , E , ρ , ν )}{2 L} - \frac{{f}_{n}}{n} \vert}^{2}$$

11. The method of claim 9, wherein the loss function Fs is defined as
$${F}_{s} = \frac{1}{N} {\sum }_{n = 1}^{N} {\vert \frac{D P R ( {f}_{n} , E , ρ , ν )}{2 L} - \frac{{f}_{n}}{n - \frac{1}{2}} \vert}^{2}$$

12. The method of claim 9, further comprising a step determining whether there is convergence between an actual value and a predicted value, and outputting the structure characterization values from the inversion process, otherwise updating the variables and returning the updated variables to the step of performing the loss function.

13. The method of claim 12, wherein updating the variables comprises the steps of at least performing a selection operator, a crossover operator and a mutation operator.

14. The method of claim 13, wherein a forward model is generated using the dispersion relation obtained for a cylindrical pile, and wherein the predicted data is generated by a forward solver based on the guided wave model.

15. A system for determining a value of at least one characteristic of a structure having a buried portion and a non-buried portion, the method comprising the steps of:
an excitation source caused to generate an excitation within the structure by applying a force on a lateral side of the non-buried portion of the structure;
one signal receiver placed on the lateral side of the non-buried portion of the structure, wherein the signal receiver acquires a response signal resulting from the excitation;
an apparatus for receiving the response signal, wherein the apparatus includes a processor, a memory for storing instructions executable by the processor to at least:
convert the response signal into response data;
determine a resonance number and a resonance frequency from the response data; and
perform an inversion process based on guided wave theory and a genetic algorithm to determine the value of the at least one characteristic of the structure.

16. The system of claim 15, wherein the inversion process is based on guided wave theory and a genetic algorithm.

17. The system of claim 16, wherein the processor executes the instructions to at least perform a loss function, and determine whether there is convergence between an actual value and a predicted value, and outputting the structure characterization values from the inversion process, otherwise updating variables associated with the at least one characteristic and returning the updated variables to the step of performing the loss function.

18. The system of claim 17, wherein the at least one characteristic of the structure is associated with at least one of a mechanical property and a geometric property of the structure.

19. The system of claim 18, wherein the mechanical property is at least one of a Young's modulus (E), density (ρ), and Poisson's ratio (v)) and the geometric property is length (L)) of the structure.

20. A computerized method of determining a value of at least one characteristic of a structure having a buried portion and a non-buried portion by applying at least one non-destructive testing (NDT) modality to the structure, the method comprising the steps of:
receiving excitation response data, wherein excitation response data is derived from a response signal acquired from one signal receiver placed on a lateral side of the non-buried portion, and wherein an excitation within the structure is caused by an excitation source placed on a lateral side of the non-buried portion;
determining a resonance number and a resonance frequency from the excitation response data; performing an inversion process based on guided wave theory and a genetic algorithm to determine the value of the at least one characteristic of the structure.

21. The method of claim 20, wherein the at least one characteristic is associated with at least one of a mechanical property and a geometric property of the structure.

22. The method of claim 21, wherein the mechanical property is at least one of a Young's modulus (E), density (ρ), and Poisson's ratio (v)) and the geometric property is length (L)) of the structure.
